(19) United States
(12) Patent Application Publication
(10) Pub. No.: US 2023/0268478 A1
(43) Pub. Date: Aug. 24, 2023

(54) METHODS FOR FABICATING HIGH CAPACITY ELECTRODES

(71) Applicant: GM GLOBAL TECHNOLOGY OPERATIONS LLC, Detroit, MI (US)

(72) Inventors: William R. Rodgers, Bloomfield Township, MI (US); Cameron Christopher ROSE, Farmington Hills, MI (US); Xiaosong HUANG, Novi, MI (US)

(73) Assignee: GM GLOBAL TECHNOLOGY OPERATIONS LLC, Detroit, MI (US)

(21) Appl. No.: 17/675,884

(22) Filed: Feb. 18, 2022

(51) Int. Cl. H01M 4/04

(52) U.S. Cl. CPC H01M 4/0411

(57) ABSTRACT

A method of fabricating an electrode is provided. The method includes adding one or more dry powders to an extruder barrel of an extruder at a first location, adding one or more solvents to the extruder barrel at a second location that is downstream of the first location to form a material mixture, applying a mixing force to the material mixture to form a paste, and extruding the paste as a continuous film onto one or more surfaces of a current collector to form the electrode. The one or more dry powders include an electroactive material. The paste is a homogeneous semi-solid having a solids content greater than or equal to about 60% to less than or equal to about 90%. The continuous film has a thickness greater than or equal to about 50 μm to less than or equal to about 500 μm.

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

### SUMMARY

This section provides a general summary of the disclosure, and is not a comprehensive disclosure of its full scope or all of its features.

The present disclosure relates to electrodes and methods of making and using the same.

In various aspects, the present disclosure provides a method of fabricating a precursor of an electrode, the electrode to be use in an electrochemical cell that cycles lithium ions. The method includes adding one or more dry powders to an extruder barrel of an extruder at a first location, adding a solvent to the extruder barrel at a second location that is downstream of the first location to form a material mixture, and applying a mixing force to the material mixture to form a paste that is a homogeneous semi-solid having a solids content greater than or equal to about 60% to less than or equal to about 90%, where the paste is the precursor for forming the electrode. The mixing force may be continuously applied within the extruder barrel.

In one aspect, the one or more dry powders may include greater than or equal to about 90 wt. % to less than or equal to about 99 wt. % of an electroactive material, and greater than or equal to about 0.5 wt. % to less than or equal to about 5 wt. % of an electronically conductive material.

In one aspect, the electronically conductive material may be a first electronically conductive material, and the method may further include adding a second electronically conductive material to the extruder barrel at a third location. The third location may be downstream of the second location. The second electronically conductive material may have an aspect ratio greater than or equal to about 10 to less than or equal to about 1000.

In one aspect, the solvent may be a first solvent, and the method may further include adding a second solvent to the extruder barrel at a fourth location. The fourth location may be downstream of the third location.

In one aspect, the one or more dry powders may further include greater than or equal to about 0.5 wt. % to less than or equal to about 9 wt. % of a binder material.

In one aspect, the method may further include adding a binder material to the extruder barrel at a third location. The third location may be downstream of the second location.

In one aspect, the solvent may be a first solvent, and the method may further include adding a second solvent to the extruder barrel at a fourth location. The fourth location may be downstream of the third location.

In one aspect, the method may further include adding a binder material to the extruder barrel at the second location.

In various aspects, the present disclosure provides a method of fabricating an electrode for use in an electrochemical cell that cycles lithium ions. The method may include adding one or more dry powders to an extruder barrel of an extruder at a first location, adding one or more solvents to the extruder barrel at a second location that is downstream of the first location to form a material mixture, applying a mixing force to the material mixture to form a paste, and extruding the paste as a continuous film onto one or more surfaces of a current collector to form the electrode. The one or more dry powders may include an electroactive material. The paste may be a homogeneous semi-solid having a solids content greater than or equal to about 60% to less than or equal to about 90%. The continuous film may have a thickness greater than or equal to about 50 μm to less than or equal to about 500 μm. The mixing force may be continuously applied within the extruder barrel.

In one aspect, the thickness may be a first thickness, and the method may further include applying a first pressure to the continuous film, such that the continuous film has a second thickness that is less than the first thickness.

In one aspect, the method may further include heating the continuous film using an oven. The oven may have a temperature greater than or equal to about 80° C. to less than or equal to about 200° C.

In one aspect, the method may further include applying a second pressure to the continuous film, such that the continuous film has a porosity greater than or equal to about 20 vol % to less than or equal to about 50 vol %.

In one aspect, the method may further include disposing a protective film onto an exposed surfaces of the continuous film. The protective film may have a thickness greater than or equal to about 10 μm to less than or equal to about 100 μm.

In one aspect, the thickness may be a first thickness, and the method may further include applying a pressure to the protective film and the continuous film so the continuous film has a second thickness that is less than the first thickness, separating the protective film and continuous film having the second thickness, and drying the continuous film having the second thickness to remove the one or more solvents.

In one aspect, the method may further include adding an electronically conductive material to the extruder barrel at a third location. The third location may be downstream of the second location.

In one aspect, the method may further include adding a binder material to the extruder barrel at a third location. The third location may be downstream of the second location.

In one aspect, the method may further include adding a binder material to the extruder barrel at the second location.

In various aspects, the present disclosure provides a method of fabricating an electrode for use in an electrochemical cell that cycles lithium ions. The method may include adding one or more dry powders to an extruder barrel of an extruder at a first location, adding one or more solvents to the extruder barrel at a second location that is downstream of the first location to form a material mixture, applying a mixing force to the material mixture to form a paste, and extruding the paste as a continuous film onto one or more surfaces of a release film. The one or more dry powders may include an electroactive material. The paste be a homogeneous semi-solid having a solids content greater than or equal to about 60% to less than or equal to about 90%. A mixing force is continuously applied within the extruder barrel. The continuous film may have a first thickness greater than or equal to about 50 μm to less than or equal to about 500 μm. The method may further include applying a first pressure to the continuous film such that the continuous film has a second thickness less than the first thickness, separating the continuous film having the second thickness and the release film, and disposing the continuous film having the second thickness on a current collector to form the electrode.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an example electrochemical battery cell that includes a first (or positive) electrode and a second (or negative) electrode;

FIG. 2 is a flowchart summarizing an example method for forming an electrode (for example, the positive electrode and/or the negative electrode as illustrated in FIG. 1) in accordance with various aspects of the present disclosure;

FIG. 3 is a flowchart summarizing another example method for forming an electrode (for example, the positive electrode and/or the negative electrode as illustrated in FIG. 1) in accordance with various aspects of the present disclosure;

FIG. 4 is a flowchart summarizing another example method for forming an electrode (for example, the positive electrode and/or the negative electrode as illustrated in FIG. 1) in accordance with various aspects of the present disclosure;

FIG. 5 is a flowchart summarizing another example method for forming an electrode (for example, the positive electrode and/or the negative electrode as illustrated in FIG. 1) in accordance with various aspects of the present disclosure;

FIG. 6 is a flowchart summarizing another example method for forming an electrode (for example, the positive electrode and/or the negative electrode as illustrated in FIG. 1) in accordance with various aspects of the present disclosure;

FIG. 7 is a flowchart summarizing another example method for forming an electrode (for example, the positive electrode and/or the negative electrode as illustrated in FIG. 1) in accordance with various aspects of the present disclosure;

FIG. 8 is a schematic illustration of an example extruder that can be used to prepare an electrode (for example, the positive electrode and/or the negative electrode as illustrated in FIG. 1 as prepared using the method illustrated in FIG. 3, the method illustrated in FIG. 4, the method illustrated in FIG. 5, the method illustrated in FIG. 6, and/or the method illustrated in FIG. 7) in accordance with various aspects of the present disclosure; and

FIG. 9 is a graphical illustration demonstrating the discharge capacity retention of an example battery cell including an electrode prepared in accordance with various aspects of the present disclosures.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

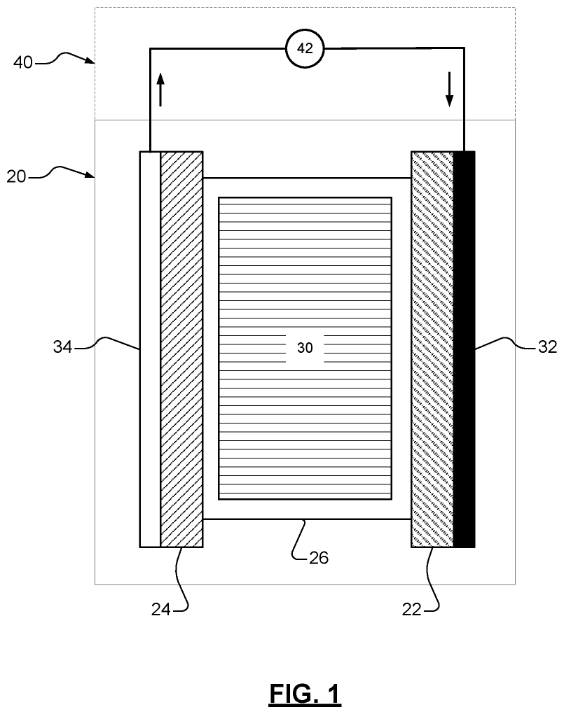

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electronically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electronically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution that includes a lithium salt (e.g. >0.8 M) dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlC₁₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In various aspects, the separator 26 may be a microporous polymeric separator. The microporous polymeric separator may include, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm. The separator 26 may have an average thickness greater than or equal to 1 μm to less than or equal to 50 μm, and in certain instances, optionally greater than or equal to 1 μm to less than or equal to 20 μm.

In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the one or more ceramic materials and/or the one or more heat-resistant materials. The one or more ceramic materials may include, for example, alumina (Al₂O₃), silica (SiO₂), and the like. The heat-resistant material may include, for example, Nomex, Aramid, and the like.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂Oi₂, Li₃xLa_{2/3}-xTiO₃, Li₃PO₄, Li₃N, Li₄GeS₄, Li₁₀GeP₂S₁₂, Li₂S—P₂S₅, Li₆PS₅C₁, Li₆PS₅Br, Li₆PS₅I, Li₃OCl, L_{12.99} Ba_{0.005}ClO, or combinations thereof. The solid-state electrolyte layer and/or semi-solid-state electrolyte layer may also include gel polymer electrolytes (polymer films with absorbed liquid electrolyte). Examples of the polymers include polyvinylidene difluoride, polyethylene glycol, polyacrylonitrile, poly(methyl methacrylate), their copolymers or combinations therefor.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. In certain variations, the negative electrode 22 may include a plurality of solid-state electrolyte particles (not shown). The negative electrode 22 may have an average thickness greater than or equal to about 1 μm to less than or equal to about 500 μm, and in certain aspects, optionally greater than or equal to about 10 μm to less than or equal to about 200 μm. The negative electrode 22 may have an average thickness greater than or equal to 1 μm to less than or equal to 500 μm, and in certain aspects, optionally greater than or equal to 10 μm to less than or equal to 200 μm.

The negative electrode 22 may include a negative electroactive material that comprises lithium, such as, for example, lithium alloys (e.g., lithium titanium oxide (LTO)) and/or lithium metal. In certain variations, the negative electrode may be a film or layer formed of lithium metal. Other materials can also be used to form the negative electrode 22, including, for example, carbonaceous materials (such as, graphite, hard carbon, soft carbon), and/or lithium-silicon, silicon containing binary and ternary alloys (e.g., Si, Li—Si, SiOx (where 0≥x≥2), FeS, and the like), and/or tin-containing alloys (e.g., Si—Sn, SiSnFe, SiSnAl, SiFeCo, SnO₂, and the like), and/or metal oxides (e.g., V₂O₅, SnO₂, Co₃O₄, and the like), and/or combinations thereof. For example, in certain variations, the negative electroactive material may include a carbonaceous-silicon based composite including, for example, about 10 wt. % SiOₓ (where 0≤x≤2) and about 90 wt. % graphite. Further still, in certain variation, the negative electroactive material may be pre-lithiated.

In various aspects, the negative electroactive material in the negative electrode 22 may be optionally intermingled with one or more electronically conductive materials that provide an electron conductive path and/or at least one polymeric binder material that improves the structural integrity of the negative electrode 22. For example, the negative electroactive material in the negative electrode 22 may be optionally intermingled (e.g., slurry cast) with binders like polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like. In certain aspects, mixtures of the conductive materials may be used.

In various aspects, the negative electrode 22 may include greater than or equal to about 10 wt. % to less than or equal to about 99 wt. %, and in certain aspects, optionally greater than or equal to about 60 wt. % to less than or equal to about 99 wt. %, of the negative electroactive material; greater than or equal to 0 wt. % to less than or equal to about 40 wt. %, and in certain aspects, optionally greater than or equal to about 0.5 wt. % to less than or equal to about 20 wt. %, of the electronically conducting material; and greater than or equal to 0 wt. % to less than or equal to about 40 wt. %, and in certain aspects, optionally greater than or equal to about 0.5 wt. % to less than or equal to about 20 wt. %, of the at least one polymeric binder.

In certain variations, the negative electrode 22 may include greater than or equal to 10 wt. % to less than or equal to 99 wt. %, and in certain aspects, optionally greater than or equal to 60 wt. % to less than or equal to 99 wt. %, of the negative electroactive material; greater than or equal to 0 wt. % to less than or equal to 40 wt. %, and in certain aspects, optionally greater than or equal to 0.5 wt. % to less than or equal to 20 wt. %, of the electronically conducting material; and greater than or equal to 0 wt. % to less than or equal to 40 wt. %, and in certain aspects, optionally greater than or equal to 0.5 wt. % to less than or equal to 20 wt. %, of the at least one polymeric binder.

The positive electrode 24 may be formed from a lithium-based active material that is capable of undergoing lithium intercalation and deintercalation, alloying and dealloying, or plating and stripping, while functioning as the positive terminal of the battery 20. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). In each instance, the positive electrode 24 may have a thickness greater than or equal to about 1 μm to less than or equal to about 500 μm, and in certain aspects, optionally greater than or equal to about 10 μm to less than or equal to about 200 μm. The positive electrode 24 may have a thickness greater than or equal to 1 μm to less than or equal to 500 μm, and in certain aspects, optionally greater than or equal to 10 μm to less than or equal to 200 μm.

In various aspects, the positive electroactive material may be an olivine compound (e.g., LiV₂(PO₄)₃ LiFePO₄, LiCoPO₄, LiMnₓFe₁₋ₓPO₄ (LMFP) (where 0.6≤x≤0.8), and the like); layered oxides having, for example, the general formula LiNiₓMn_{y}Co_{z}Al(_{(1-x-y-z)}O₂ (where 0.33≤x≤0.8, 0.1≤y≤0.33, 0.1≤z≤0.33), LiNiₓMn_{y}Co_{1-x-y}O₂(where 0.33≤x≤0.8 and 0.1≤y≤0.33), LiNiₓMni₁₋ₓO₂(where 0≤x≤1), (e.g., LiCoO₂, LiNiO₂, LiMnO₂, LiNi_{0.5}Mn_{0.5}O₂, NMC111, NMC523, NMC622, NMC721, NMC811, NCA, NCMA, and the like); spinel compounds (e.g., LiMn₂O₄, LiNi_{0.5}Mn _{1.5}O₄, and the like); tavorite compounds (e.g., LiVPO₄F and the like); borate compounds (e.g., LiFeBO₃, LiCoB₀₃, LiMnBO₃, and the like); silicate compounds (e.g., Li₂FeSiO₄, Li₂MnSiO₄, LiMnSiO₄F, and the like); organic compounds (e.g., dilithium (2,5-dilithiooxy)terephthalate, polyimide, and the like), and combinations thereof.

In various aspects, the positive electroactive material in the positive electrode 24 may be optionally intermingled with one or more electronically conductive materials that provide an electron conductive path and/or at least one polymeric binder material that improves the structural integrity of the positive electrode 24. For example, the positive electroactive material in the positive electrode 24 may be optionally intermingled (e.g., slurry cast) with binders like polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like. In certain aspects, mixtures of the conductive materials may be used.

In various aspects, the positive electrode 24 may include greater than or equal to about 10 wt. % to less than or equal to about 99 wt. %, and in certain aspects, optionally include greater than or equal to about 90 wt. % to less than or equal to about 99 wt. %, of the positive electroactive material; greater than or equal to 0 wt. % to less than or equal to about 40 wt. %, optionally greater than or equal to about 0.5 wt. % to less than or equal to about 20 wt. %, and in certain aspects, optionally greater than or equal to about 0.5 wt. % to less than or equal to about 5 wt. %, of the electronically conducting material; and greater than or equal to 0 wt. % to less than or equal to about 40 wt. %, optionally greater than or equal to about 0.5 wt. % to less than or equal to about 20 wt. %, and in certain aspects, optionally greater than or equal to about 0.5 wt. % to less than or equal to about 9 wt. %, of the at least one polymeric binder.

In certain variations, the positive electrode 24 may include greater than or equal to 10 wt. % to less than or equal to 99 wt. %, and in certain aspects, optionally include greater than or equal to 90 wt. % to less than or equal to 99 wt. %, of the positive electroactive material; greater than or equal to 0 wt. % to less than or equal to 40 wt. %, optionally greater than or equal to 0.5 wt. % to less than or equal to 20 wt. %, and in certain aspects, optionally greater than or equal to 0.5 wt. % to less than or equal to 5 wt. %, of the electronically conducting material; and greater than or equal to 0 wt. % to less than or equal to 40 wt. %, optionally greater than or equal to 0.5 wt. % to less than or equal to 20 wt. %, and in certain aspects, optionally greater than or equal to 0.5 wt. % to less than or equal to 9 wt. %, of the at least one polymeric binder.

In various aspects, the present disclosure provides methods for preparing electrodes, like the negative electrode 22 and/or the positive electrode 24 illustrated in FIG. 1. The methods may generally include preparing a paste (or mixture or slurry or dough) and contacting the paste to one or more surfaces of a current collector. The paste may be prepared by adding materials to an extruder (for example, to one or more sections of an extruder barrel or mixing chamber), and the extruder may be configured to extrude a film onto or near the one or more surfaces of the current collector. The paste may be a homogeneous semi-solid.

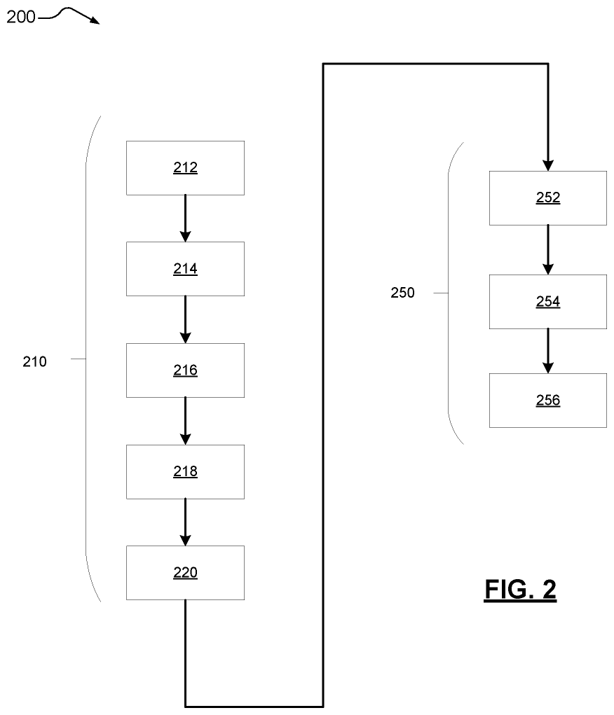

FIG. 2 illustrates an example method 200 for preparing an electrode, like the negative electrode 22 and/or the positive electrode 24 illustrated in FIG. 1. The method 200 is a continuous process that includes preparing 210 a paste and contacting 250 the paste to one or more surfaces of a current collector. Preparing 210 the paste may include introducing (or adding or feeding) 214 a dry powder mixture into an extruder, and more particularly, into a barrel (or channel or mixing chamber) of the extruder at a first location (or first barrel segment or first barrel section or first barrel). Preparing 210 the paste may further include applying 216 a mixing force to the dry powder mixture such that the mixture is blended through the action of the extruder (and in particular, mixing screws within the extruder). The skilled artisan will recognize that in certain variations, the mixing force may be applied by the extruder screws as the dry powder mixture is added to the barrel.

In each instance, the dry powder mixture includes an electroactive material (for example, a positive electroactive material when forming a positive electrode, and a negative electroactive material when forming a negative electrode). In certain variations, the dry powder mixture may also include one or more binders and/or one or more electronically conductive materials. In certain variations, the method 200 may include preparing 212 the dry powder mixture. The dry powder mixture may be prepared 212 by contacting the electroactive material and optionally the one or more binders and/or the one or more electronically conductive materials. In other variations, the method 200 may include feeding 214 the dry powders—the electroactive material and optionally the one or more binders and/or the one or more electronically conductive materials—concurrently into the extruder barrel.

In each variation, the as prepared dry powder mixture, or the formed dry powder mixture, includes greater than or equal to about 90 wt. % to less than or equal to about 99 wt. %, optionally greater than or equal to about 94 wt. % to less than or equal to about 97 wt. %, and in certain aspects, optionally greater than or equal to about 92 wt. % to less than or equal to about 95 wt. %, of the electroactive material; greater than or equal to about 0.5 wt. % to less than or equal to about 9 wt. %, optionally greater than or equal to about 1 wt. % to less than or equal to about 8 wt. %, optionally greater than or equal to about 1.5 wt. % to less than or equal to about 7 wt. %, and in certain aspects, optionally greater than or equal to about 3 wt. % to less than or equal to about 5 wt. %, of the one or more binders; and greater than or equal to about 0.5 wt. % to less than or equal to about 5 wt. %, optionally greater than or equal to about 1 wt. % to less than or equal to about 4.5 wt. %, greater than or equal to about 1.5 wt. % to less than or equal to about 4 wt. %, and in certain aspects, optionally greater than or equal to about 2 wt. % to less than or equal to about 3 wt. %, of the one or more electronically conductive materials, and the feed rate (for example, throughout the process 200) may be greater than or equal to about 10% to less than or equal to about 80%, and in certain aspects, optionally greater than or equal to about 30% to less than or equal to about 60%, of a rated capacity of the extruder.

In certain variations, the as prepared dry powder mixture, or the formed dry powder mixture, includes greater than or equal to 90 wt. % to less than or equal to 99 wt. %, optionally greater than or equal to 94 wt. % to less than or equal to 97 wt. %, and in certain aspects, optionally greater than or equal to 92 wt. % to less than or equal to 95 wt. %, of the electroactive material; greater than or equal to 0.5 wt. % to less than or equal to 9 wt. %, optionally greater than or equal to 1 wt. % to less than or equal to 8 wt. %, optionally greater than or equal to 1.5 wt. % to less than or equal to 7 wt. %, and in certain aspects, optionally greater than or equal to 3 wt. % to less than or equal to 5 wt. %, of the one or more binders; and greater than or equal to 0.5 wt. % to less than or equal to 5 wt. %, optionally greater than or equal to 1 wt. % to less than or equal to 4.5 wt. %, greater than or equal to 1.5 wt. % to less than or equal to 4 wt. %, and in certain aspects, optionally greater than or equal to 2 wt. % to less than or equal to 3 wt. %, of the one or more electronically conductive materials, and the feed rate (for example, throughout the process 200) may be greater than or equal to 0% to less than or equal to 80%, and in certain aspects, optionally greater than or equal to 30% to less than or equal to 60%, of a rated capacity of the extruder.

Various extruders may be used, including, for example only, a twin screw extruder (including full intermeshing, partial intermeshing, or tangential intermeshing) or a conical twin screw extruder or a kneader style extruder (e.g., Buss Kneader). In each variation, the extruder is configured to exert a continuous mixing force. For example, in certain variations, the continuous mixing force may be applied using one or more screws. In such instances, the rotation speed of the mixing screws may be selected so as to allow for good mixing (as recognized by the skilled artisan), while avoiding or limiting damage to the dry powders (for example, without degradation of the particle sizes of the dry powders). The rotation speed of the mixing screws may be (for example, throughout the process 200) greater than or equal to about 10% to less than or equal to about 70%, and in certain aspects, optionally greater than or equal to about 30% to less than or equal to about 50%, of the machine rated rotation speed for the selected extruder. In certain instances, the rotation speed of the mixing screws may be (for example, throughout the process 200) greater than or equal to 10% to less than or equal to 70%, and in certain aspects, optionally greater than or equal to 30% to less than or equal to 50%, of the machine rated rotation speed for the selected extruder.

In each variation, a temperature of the extruder barrel may be maintained (for example, throughout the process 200) at greater than or equal to about ˜20° C. to less than or equal to about 200° C., optionally greater than or equal to about ˜10° C. to less than or equal to about 120° C., optionally greater than or equal to about 0° C. to less than or equal to about 80° C., and in certain aspects optionally greater than or equal to about 25° C. to less than or equal to about 35° C. In certain variations, the temperature of the extruder barrel may be maintained (for example, throughout the process 200) at greater than or equal to ˜20° C. to less than or equal to 200° C., optionally greater than or equal to ˜10° C. to less than or equal to 120° C., optionally greater than or equal to 0° C. to less than or equal to 80° C., and in certain aspects optionally greater than or equal to 25° C. to less than or equal to 35° C.

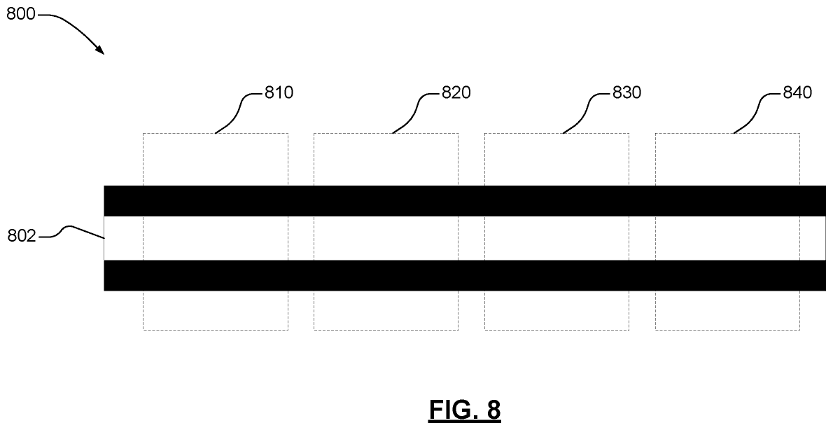

In various aspects, preparing the paste 210 may further include, introducing or adding or feeding 218 a solvent into the extruder barrel to from the paste. For example, the solvent may be introduced into an extruder barrel at a second location (or second barrel segment or second barrel section or second barrel).The second location is downstream from the first location (for example, as illustrated in FIG. 8, which is a schematic illustration of an example extruder 800). Preparing 210 the paste may further include applying 220 a mixing force to the dry powder mixture and solvent such that they are blended through the action of the extruder (and in particular, mixing screws within the extruder). The skilled artisan will recognize that in certain variations, the mixing force may be applied by the extruder screws as the solvent is added to the barrel.

In various aspects, the solvent may include, for example, n-methyl-2-pyrrolidone (NMP), isopropyl alcohols, water, or other solvents capable of dissolving or being miscible with the selected binders. More particularly, in the instance of positive electroactive materials, the solvent may include for example, n-methyl-2-pyrrolidone (NMP), isopropyl alcohols, or other solvents capable of dissolving or being miscible with the selected binders; and in the instance of negative electroactive materials, the solvent may include, for example, n-methyl-2-pyrrolidone, isopropyl alcohols, water, or other solvents capable of dissolving or being miscible with the selected binders. After the introduction of the solvent, the paste may have a solids content greater than or equal to about 60% to less than or equal to about 90%, and in certain aspects, optionally greater than or equal to about 65% to less than or equal to about 85%. In certain instances, the paste may have a solids content greater than or equal to 60% to less than or equal to 90%, and in certain aspects, optionally greater than or equal to 65% to less than or equal to 85%.

The contacting 250 may include extruding 252 the paste as a film onto or near one or more surfaces of the current collector. For example, the paste may be coated on the one or more surfaces of the current collector using a film deposition process, as the current collector is removed from a supply roll. However, any extruding process or design that extrudes films that have substantially uniform thickness may be employed. For example, in certain variations, an extruding die having a coat hanger design may be employed. In each instance, the extruded film may have a substantially uniform thickness. For example, the film may be a continuous film having a first thickness greater than or equal to about 50 μm to less than or equal to about 500 μm, optionally greater than or equal to about 75 μm to less than or equal to about 450 μm, optionally greater than or equal to about 100 μm to less than or equal to about 400 μm, and in certain aspects, optionally greater than or equal to about 150 μm to less than or equal to about 350 μm. In certain variations, the first thickness may be greater than or equal to 50 μm to less than or equal to 500 μm, optionally greater than or equal to 75 um to less than or equal to 450 μm, optionally greater than or equal to 100 μm to less than or equal to 400 μm, and in certain aspects, optionally greater than or equal to 150 um to less than or equal to 350 μm.

By way of non-limiting example, in certain variations, the paste to be extruded may include about 65% (optionally about 67%, and in certain aspects, optionally about 70%) of solids in n-methyl-2-pyrrolidone (NMP), where the solids include a weight ratio of 92:3:5 of LiMnFePO4 (LMFP): Super-P: polyvinylidene fluoride (PVdF). In other variations, the paste to be extruded may include about 70% of solids in n-methyl-2-pyrrolidone (NMP), where the solids include a weight ratio of 96:2:2 of LiMnFePO₄ (LMFP): Super-P: polyvinylidene fluoride (PVdF). In still other variations, the paste to be extruded may include about 80% of solids in n-methyl-2-pyrrolidone (NMP), where the solids include a weight ratio of 48.5:48.5:1.5:1.5 of LiMnFePO₄ (LMFP): NMC622: Carbon additives: polyvinylidene fluoride (PVdF).

Similarly, in certain variations, the paste to be extruded may include about 80% of solids in n-methyl-2-pyrrolidone (NMP), where the solids include a weight ratio of 48.5:48.5:1.5:1.5 of LiMnFePO₄ (LMFP): NCMA: carbon fillers: polyvinylidene fluoride (PVdF). Additionally, in certain variations the paste to be extruded may include about 80% of solids in n-methyl-2-pyrrolidone (NMP), where the solids include a weight ratio of 29.1:67.9:1.5:1.5 of LiMnFePO₄ (LMFP): NCMA: carbon fillers: polyvinylidene fluoride (PVdF). Further, in certain variations, the paste to be extruded may include about 87% of solids in n-methyl-2-pyrrolidone (NMP), where the solids include a weight ratio of 97:1.5:1.5 of NCM622: carbon fillers: polyvinylidene fluoride (PVdF). Further still, in certain variations, the paste to be extruded may include about 87% of solids in n-methyl-2-pyrrolidone (NMP), where the solids include a weight ratio of 97:1.5:1.5 of NCMA: carbon fillers: polyvinylidene fluoride (PVdF).

In sum, when the electroactive material includes of LiMnFePO₄ (LMFP), the paste may have a solids content of greater or equal to about 65% and less than or equal to about 75%, and in certain aspects, optionally greater or equal to 65% and less than or equal to 75%. When the electroactive material includes one or both of NMC and NMCA, the paste may have a solids content of greater than or equal to about 80% and less than or equal to about 90%, and in certain aspects, optionally greater than or equal to 80% and less than or equal to 90%. When the electroactive material includes a blend of NMC and LiMnFePO₄ (LMFP), the paste may have a solids content of greater than or equal to about 75% and less than or equal to about 85%, and in certain aspects, optionally greater than or equal to 75% and less than or equal to 85%. When the electroactive material includes a blend of NMCA and LiMnFePO₄ (LMFP), the paste may have a solids content of greater than or equal to about 75% and less than or equal to about 85%, and in certain aspects, optionally greater than or equal to 75% and less than or equal to 85%.

With renewed reference to FIG. 2, in various aspects, the contacting 250 may further include calendering 254 the assembly (including the current collector and the continuous film) to form an electrode that has a second thickness, where the second thickness is less than the first thickness. The second thickness may be greater than or equal to about 50 μm to less than or equal to about 400 μm, and in certain aspects, optionally greater than or equal to 50 μm to less than or equal to 400 μm. In various aspects, the calendering 254 may include moving the assembly between or along a plurality of rollers. The plurality of rollers may include, for example, a pair of rollers configured to apply a pressure greater than or equal to about 2 MPa to less than or equal to about 25 MPa, and in certain aspects, optionally greater than or equal to 2 MPa to less than or equal to 25 MPa, on the assembly.

In still further variations, the contacting 250 may include drying 256 the continuous film to remove solvent using, for example, a drying oven having a temperature greater than or equal to about 80° C. to less than or equal to about 200° C., and in certain aspects, optionally greater than or equal to 80° C. to less than or equal to 200° C., for a time period. The time period may be greater than or equal to about 1 minutes to less than or equal to about 20 minutes, optionally greater than or equal to about 2 minutes to less than or equal to about 20 minutes, optionally greater than or equal to about 1 minutes to less than or equal to about 18 minutes, optionally greater than or equal to about 2 minutes to less than or equal to about 15 minutes, and in certain aspects, optionally greater than or equal to about 2 minutes to less than or equal to about 12 minutes. In certain variations, the time period may be greater than or equal to 1 minutes to less than or equal to 20 minutes, optionally greater than or equal to 2 minutes to less than or equal to 20 minutes, optionally greater than or equal to 1 minutes to less than or equal to 18 minutes, optionally greater than or equal to 2 minutes to less than or equal to 15 minutes, and in certain aspects, optionally greater than or equal to 2 minutes to less than or equal to 12 minutes.

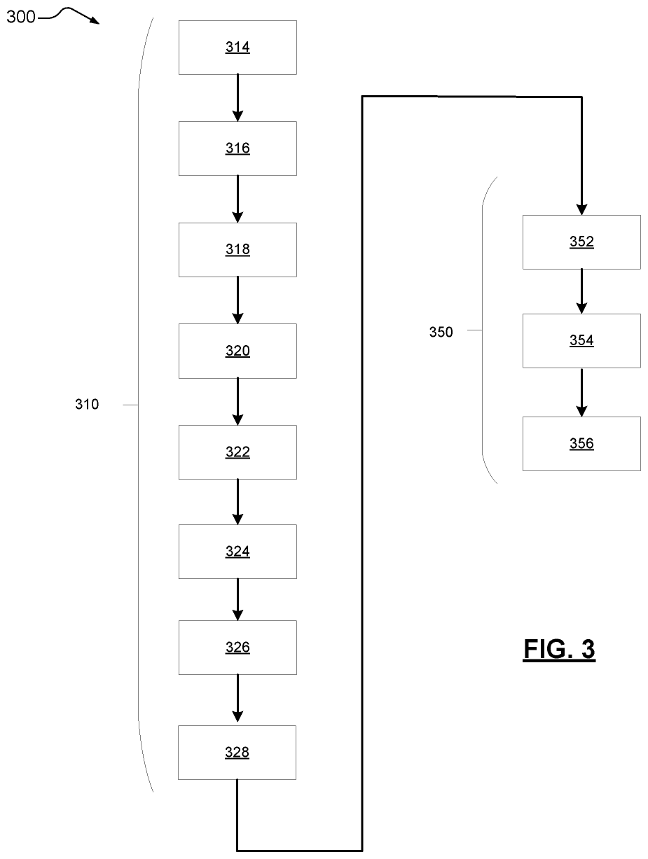

FIG. 3 illustrates another example method 300 for preparing an electrode, like the negative electrode 22 and/or the positive electrode 24 illustrated in FIG. 1. Like method 200 illustrated in FIG. 2, the method 300 includes preparing 310 a paste and contacting 350 the paste to one or more surfaces of a current collector, where the preparing 310 includes introducing 314 a dry powder mixture at a first location of the extruder barrel and applying 316 a mixing force, and introducing 318 a first portion of a solvent into the barrel at a second location, which is downstream of the first location, and applying 320 a mixing force, and the contacting 350 includes extruding 352 the paste as a film onto or near one or more surfaces of the current collector, calendering 354 the assembly (including the current collector and the continuous film) to form an electrode, and drying 356 the electrode to remove solvent. In certain variations, preparing 310 may further include preparing 312 the dry powder mixture.

The method 300 further includes, however, introducing (or adding or feeding) at a third location a second electronically conductive material into the barrel (or channel or mixing chamber) of the extruder. The third location is downstream from the second location (for example, as illustrated in FIG. 8, which is a schematic illustration of an example extruder 800). Preparing 310 the paste may further include applying 324 a mixing force to the dry powder mixture, first portion of the solvent, and the second electronically conductive material such that the materials are blended through the action of the extruder (and in particular, mixing screws within the extruder). The skilled artisan will recognize that in certain variations, the mixing force may be applied by the extruder screws as the second electronically conductive material is added to the barrel.

The second electronically conductive material may have a comparatively high aspect ratio. For example, the second electronically conductive material may have an aspect ratio greater than or equal to about 10 to less than or equal to about 1000, and in certain aspects, optionally greater than or equal to 10 to less than or equal to 1000. In certain variations, the second electronically conductive materials may include carbon nanofibers and nanotubes (e.g., single wall carbon nanotubes (SWCNT), multiwall carbon nanotubes (MWCNT)), graphene (e.g., graphene platelets (GNP), oxidized graphene platelets), nickel and other metal fibrils, and the like. Adding the second electronically conductive material later in the process, as detailed, provides for better distributive mixing of the second electronically conductive materials while lessening the chances for the comminution of the aspect ratios of the second electronically conductive material because the overall mixing time for the second electronically conductive material is less as a result of its downstream introduction.

The method 300 may further include, introducing (or adding or feeding) 326 at a fourth location a second portion of the solvent into the barrel (or channel or mixing chamber) of the extruder. The fourth location is downstream from the third location (for example, as illustrated in FIG. 8, which is a schematic illustration of an example extruder 800). Preparing 310 the paste may further include applying 328 a mixing force to the dry powder mixture, first portion of the solvent, the second electronically conductive material, and the second portion of the solvent such that the materials are blended through the action of the extruder (and in particular, mixing screws within the extruder). The skilled artisan will recognize that in certain variations, the mixing force may be applied by the extruder screws as the second portion of the solvent is added to the barrel. The addition of the second portion of the solvent is performed to dilute the combination (i.e., the dry powder mixture, the second electronically conductive material, and the one or more binders) to achieve the desired solids content. For example, it may be desirable for the paste to have a solids content greater than or equal to about 65% to less than or equal to about 90%, and in certain aspects, optionally greater than or equal to about 70% to less than or equal to about 90%. In certain variations, the paste may have a solids content greater than or equal to 65% to less than or equal to 90%, and in certain aspects, optionally greater than or equal to 70% to less than or equal to 90%.

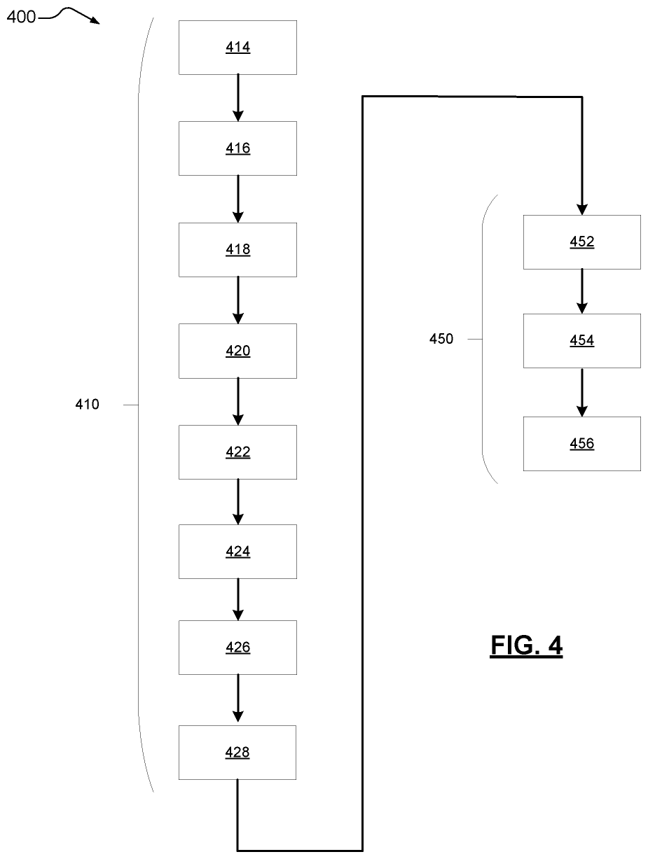

FIG. 4 illustrates still another example method 400 for preparing an electrode, like the negative electrode 22 and/or the positive electrode 24 illustrated in FIG. 1. Like method 200 illustrated in FIG. 2 and/or the method 300 illustrated in FIG. 3, the method 400 includes preparing 410 a paste and contacting 450 the paste to one or more surfaces of a current collector, where the preparing 410 includes introducing 414 a dry powder mixture at a first location of the extruder barrel and applying 416 a mixing force, and introducing 418 a first portion of a solvent into the barrel at a second location, which is downstream of the first location, and applying 420 a mixing force, and the contacting 450 includes extruding 452 the paste as a film onto or near one or more surfaces of the current collector, calendering 454 the assembly (including the current collector and the continuous film) to form an electrode, and drying 456 the electrode to remove solvent. In certain variations, preparing 410 may further include preparing 412 the dry powder mixture.

In the instance of method 400, however, the dry powder mixture does not include the binder material. Rather, the method 400 includes introducing (or adding or feeding) 422 one or more binders into the barrel (or channel or mixing chamber) of the extruder at a third location. The third location is downstream from the second location (for example, as illustrated in FIG. 8, which is a schematic illustration of an example extruder 800). Preparing 410 the paste may further include applying 424 a mixing force to the dry powder mixture, first portion of the solvent, and the one or more binders such that the mixture is blended through the action of the extruder (and in particular, mixing screws within the extruder). The skilled artisan will recognize that in certain variations, the mixing force may be applied by the extruder screws as the second electronically conductive material is added to the barrel.

The method 400 may further include, introducing (or adding or feeding) 426 at a fourth location a second portion of the solvent into the barrel (or channel or mixing chamber) of the extruder. The fourth location is downstream from the third location (for example, as illustrated in FIG. 8, which is a schematic illustration of an example extruder 800). Preparing 410 the paste may further include applying 428 a mixing force to the dry powder mixture, first portion of the solvent, the one or more binders, and the second portion of the solvent such that the mixture is blended through the action of the extruder mixing screws. The skilled artisan will recognize that in certain variations, the mixing force may be applied by the extruder screws as the second portion of the solvent is added to the barrel. The additional of the second portion of the solvent is performed to dilute the combination (i.e., the dry powder mixture, the first portion of the solvent, and the one or more binders) to achieve the desired solids content. For example, it may be desirable for the paste to have a solids content greater than or equal to about 65% to less than or equal to about 90%, and in certain aspects, optionally greater than or equal to about 70% to less than or equal to about 90%. In certain variations, the paste may have a solids content greater than or equal to 65% to less than or equal to 90%, and in certain aspects, optionally greater than or equal to 70% to less than or equal to 90%.

In other variations, although not illustrated, the one or more binders may be introduced into the extruder barrel with the first portion of the solvent at the second location, such that steps 422, 424, 426, and 428 can be omitted.

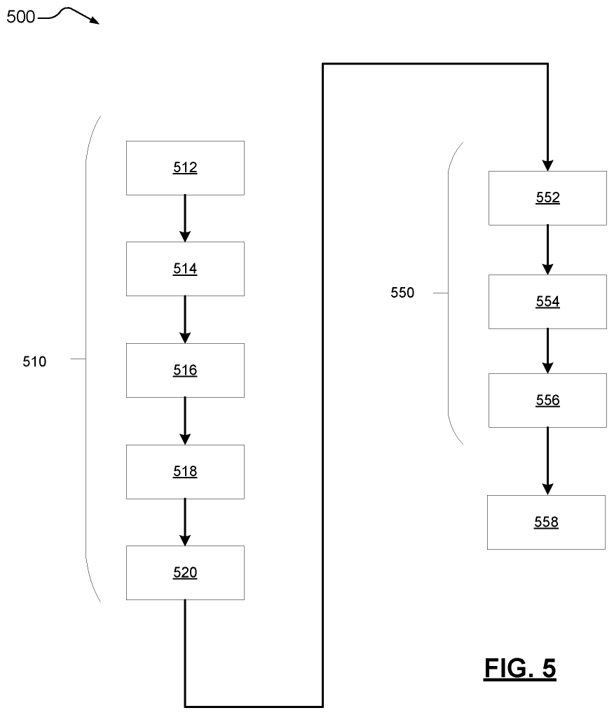

FIG. 5 illustrates yet another example method 500 for preparing an electrode, like the negative electrode 22 and/or the positive electrode 24 illustrated in FIG. 1. Like method 200 illustrated in FIG. 2 and/or the method 300 illustrated in FIG. 3 and/or the method 400 illustrated in FIG. 4, the method 500 includes preparing 510 a paste and contacting 550 the paste to one or more surfaces of a current collector, where the preparing 510 includes introducing 514 a dry powder mixture at a first location of the extruder barrel and applying 516 a mixing force, and introducing 518 a first portion of a solvent into the barrel at a second location, which is downstream of the first location, and applying 520 a mixing force, and the contacting 550 includes extruding 552 the paste as a film onto or near one or more surfaces of the current collector, calendering 554 the assembly (including the current collector and the continuous film) to form an electrode, and drying 556 the electrode to remove solvent. In certain instances, preparing 510 may further include preparing 512 the dry powder mixture.

The method 500 may further include calendering 558 the electrode (including the current collector and the dried film) to form an electrode having an electroactive material layer with a pre-selected porosity. For example, it may be desirable for the electroactive material layer to have a porosity greater than or equal to about 20 vol % to less than or equal to about 50 vol %, and in certain aspects, optionally greater than or equal to about 30 vol % to less than or equal to about 40 vol %. In certain variations, it may be desirable for the electroactive material layer to have a porosity greater than or equal to 20 vol % to less than or equal to 50 vol %, and in certain aspects, optionally greater than or equal to 30 vol % to less than or equal to 40 vol %.

Calendering 558 may include moving the assembly between or along a plurality of rollers. The plurality of rollers may include, for example, a pair of rollers configured to apply a pressure greater than or equal to about 2 MPa to less than or equal to about 25 MPa, and in certain aspects, optionally greater than or equal to 2 MPa to less than or equal to 25 MPa, on the electrode.

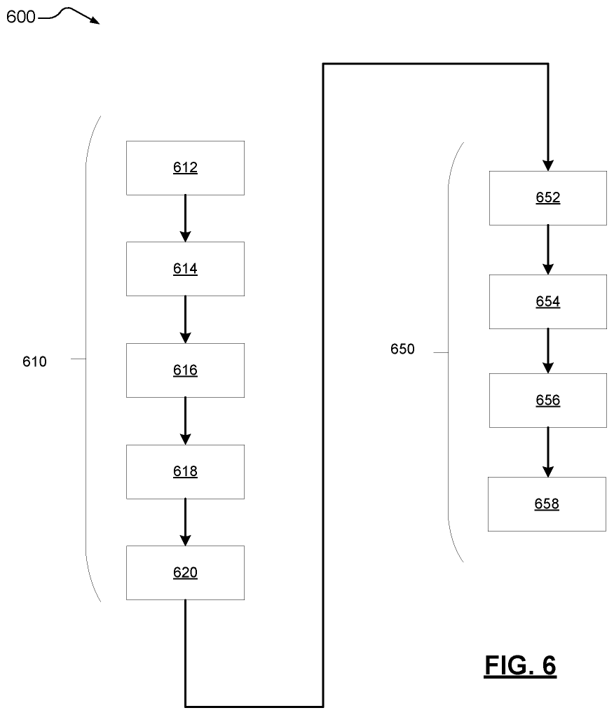

FIG. 6 illustrates yet another example method 600 for preparing an electrode, like the negative electrode 22 and/or the positive electrode 24 illustrated in FIG. 1. Like method 200 illustrated in FIG. 2 and/or the method 300 illustrated in FIG. 3 and/or the method 400 illustrated in FIG. 4 and/or the method 500 illustrated in FIG. 5, the method 600 includes preparing 610 a paste and contacting 650 the paste to one or more surfaces of a current collector, where the preparing 610 includes introducing 614 a dry powder mixture at a first location of the extruder barrel and applying 616 a mixing force, and introducing 618 a first portion of a solvent into the barrel at a second location, which is downstream of the first location, and applying 620 a mixing force. In certain instances, preparing 610 may further include preparing 612 the dry powder mixture. In this instance, the contacting 650 includes extruding 652 the paste as a film onto or near one or more surfaces of the current collector, and further includes, prior to the calendering 656, disposing 654 a protective film on or near one or more exposed surfaces of the current collector. The protective film may be removed from a supply roller and fed into the extrusion line. In curtain variations, the current collector and the protective film may be aligned simultaneously with the extruded film.

In each variation, the protective film prevents the film from sticking to the calender rolls when the assembly (including the current collector and the continuous film) is calendered 656 to form an electrode. The protective film may have a thickness greater than or equal to about 10 μm to less than or equal to about 100 μm, and in certain aspects, optionally greater than or equal to about 20 μm to less than or equal to about 100 μm. In certain variations, the thickness may be greater than or equal to 10 μm to less than or equal to 100 μm, and in certain aspects, optionally greater than or equal to 20 μm to less than or equal to 100 μm. In each instance, the protective film may include one or more materials selected form the group consisting of: polytetrafluoroethylene, polychlorotrifluoroethylene, siliconized polyethylene terephthalate, siliconized low density polyethylene, siliconized, high density polyethylene, and siliconized polypropylene, and combinations thereof. In various aspects, the method 600 may further include removing the protective film prior to the drying 658 of the electrode. In certain variations, the protective film may be removed by stripping the film and collecting on a take-up roll prior to entering the drying oven.

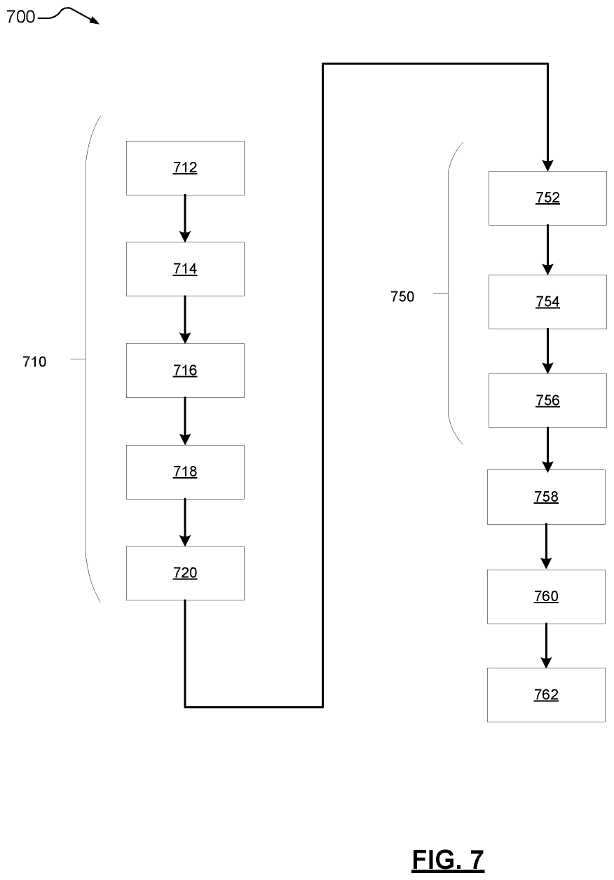

FIG. 7 illustrates yet another example method 700 for preparing an electrode, like the negative electrode 22 and/or the positive electrode 24 illustrated in FIG. 1. Like method 200 illustrated in FIG. 2 and/or the method 300 illustrated in FIG. 3 and/or the method 400 illustrated in FIG. 4 and/or the method 500 illustrated in FIG. 5 and/or the method 600 illustrated in FIG. 6, the method 700 includes preparing 710 a paste and contacting 750 the paste to one or more surfaces of a current collector, where the preparing 710 includes introducing 714 a dry powder mixture at a first location of the extruder barrel and applying 716 a mixing force, and introducing 718 a first portion of a solvent into the barrel at a second location, which is downstream of the first location, and applying 720 a mixing force. In certain instances, preparing 710 may further include preparing 712 the dry powder mixture. In this instance, the contacting 750 includes extruding 752 the paste as a film onto or near a release film instead of a current collector. The contacting 750 may further include calendering 754 the assembly (including the release film and the continuous film) to form a precursor electrode including an electroactive material layer on or near the release film, and drying 756 the precursor electrode to remove excess solvent. In each variation, the release film is selected so as to survive subsequent drying 756 of the precursor electrode. For example, the release film may include one or more materials selected from the group consisting of: polytetrafluoroethylene, polychlorotrifluoroethylene, siliconized polyethylene terephthalate, siliconized low density polyethylene, siliconized, high density polyethylene, siliconized polypropylene, and combinations thereof.

In various aspects, the method 700 may further include removing 758 the release layer from the electroactive material layer, and disposing 762 the electroactive material layer on or near one or more surfaces of a current collector to form an electrode. For example, the electroactive material layer may be laminated onto the current collector. In certain variations, a conductive adhesive may be needed to adhere the electroactive material layer to the current collector. In such instances, the method may include contacting 760 the one or more surfaces of the current collector with the conductive adhesive prior to disposing 762 the electroactive material layer on or near the one or more surfaces of the current collector.

Although not specifically illustrated, the skilled artisan will understand that various combinations of the above detailed methods (including method 200, method 300, method 400, method 500, method 600, and/or method 700) may be used in different instances. Likewise, although not illustrated, the skilled artisan will understand that, in certain instances, one or more of the above detailed methods, or combinations thereof, may further include preparing an electrode reel that can be stored and used during later processing. The electrode reel may be prepared by winding the electrode (or precursor electrode in the instance of method 700) around a spool. The skilled artisan will also understand that, in certain instances, one or more of the above detailed methods, or combinations thereof, may further include cutting or slicing the prepared electrode (and/or precursor electrode) to produce a plurality of electrodes having clean edges on one or more sides. Further, the skilled artisan will understand that, in certain instances, one or more of the above detailed methods, or combinations thereof, may include aligning the prepared electrode (for example, from the electrode reel and/or the sliced electrodes) with one or more other electrode and a separator (or a solid-state electrolyte in the instance of a solid-state battery) to prepare a battery cell, like the battery 20 illustrated in FIG. 1. Further still, the skilled artisan will understand that, in certain instances, one or more of the above detailed methods, or combinations thereof, may include degassing the paste prior to contacting the current collector or the release film. In various aspects, degassing may include allowing an open port downstream in the extruder which entrained gasses may be removed. In certain variations, the open port may optionally be equipped to allow the application of a vacuum to assist in the removal of untreated gasses from the mixture.

In each variation, the detailed methods or combinations thereof, may allow the preparation of electrode pastes at higher solids contents and faster production rates than the standard slurry casting processes. For example, the detailed methods, or combinations thereof, may be particularly useful for active materials having high surfaces areas (e.g., greater than or equal to about 15 m²/g to less than or equal to about 35 m²/g, and in certain aspects, optionally greater than or equal to 15 m²/g to less than or equal to 35 m²/g) that are often difficult to incorporate using conventional paste processes, such a small particle size (e.g., greater than or equal to about 1.5 μm to less than or equal to about 100 μm, and in certain aspects, optionally greater than or equal to 1.5 μm to less than or equal to 100 μm) olivine materials like LiMnₓFe₁₋ₓPO₄ (where 0.6≤x≤0.8).

FIG. 8 is an illustration of an example extruder 800 that can be used in accordance with one or more of the above detailed methods (for example, method 200 illustrated in FIG. 2, the method 300 illustrated in FIG. 3, the method 400 illustrated in FIG. 4, the method 500 illustrated in FIG. 5, the method 600 illustrated in FIG. 6, and/or the method 700 illustrated in FIG. 7) to prepare an electrode (for example, the positive electrode 24 and/or the negative electrode 22 as illustrated in FIG. 1). As illustrated, the extruder 800 may include a barrel (or channel or mixing chamber) 802. The barrel 802 may have a plurality of barrel segments or sections at which points introductions or additions may be may to the barrel 802. For example, as illustrated, the barrel 802 may have a first barrel segment or location 810, a second barrel segment or location 820 that is downstream of the first location 810, a third barrel segment or location 830 that is downstream of the second location 820, and/or a fourth barrel segment or location 840 that is downstream of the third location 830. The skilled artisan will recognize that, in various aspects, the barrel 802 may have fewer or more segments (or sections or locations).

Certain features of the current technology are further illustrated in the following non-limiting examples.

### EXAMPLE 1

Example battery cells may be prepared in accordance with various aspects of the present disclosure.

For example, an example battery cell 810 may include an electrode prepared in accordance with various aspects of the present disclosure. The example battery cell 810 includes an electrode having a porosity of about 35% and including about 97% of an electroactive material, about 1.5 wt. % of an electronically conductive material, and about 1.5 wt. % of a binder. The electrode may be a positive electrode, where the electroactive material includes a blend of LMFP and NCMA (50:50). The electronically conductive material may include Super P, single wall carbon nanotubes (SWCNT), and graphene platelets (GNP).

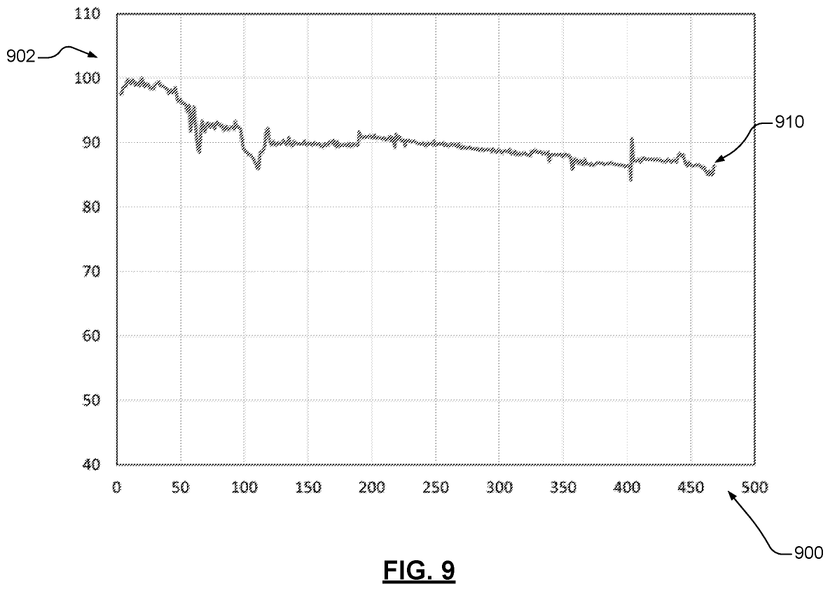

FIG. 9 is a graphical illustration demonstrating the discharge capacity retention of the example battery 910, where the x-axis 900 represents the cycle number, and the y-axis 902 represents discharge capacity retention (%). As illustrated, the example battery cell 910 has a first cycle efficiency of about 88.2%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of fabricating a precursor of an electrode, the electrode to be use in an electrochemical cell that cycles lithium ions, the method comprising:
adding one or more dry powders to an extruder barrel of an extruder at a first location;
adding a solvent to the extruder barrel at a second location that is downstream of the first location to form a material mixture; and
applying a mixing force to the material mixture to form a paste that is a homogeneous semi-solid having a solids content greater than or equal to about 60% to less than or equal to about 90%, wherein a mixing force is continuously applied within the extruder barrel and the paste is the precursor for forming the electrode.

2. The method of claim 1, wherein the one or more dry powders comprise:
greater than or equal to about 90 wt. % to less than or equal to about 99 wt. % of an electroactive material; and
greater than or equal to about 0.5 wt. % to less than or equal to about 5 wt. % of an electronically conductive material.

3. The method of claim 2, wherein the electronically conductive material is a first electronically conductive material, and the method further comprises:
adding a second electronically conductive material to the extruder barrel at a third location, wherein the third location is downstream of the second location, and the second electronically conductive material has an aspect ratio greater than or equal to about 10 to less than or equal to about 1000.

4. The method of claim 3, wherein the solvent is a first solvent, and the method further comprises:
adding a second solvent to the extruder barrel at a fourth location, wherein the fourth location is downstream of the third location.

5. The method of claim 2, wherein the one or more dry powders further comprise:
greater than or equal to about 0.5 wt. % to less than or equal to about 9 wt. % of a binder material.

6. The method of claim 2, wherein the method further comprises:
adding a binder material to the extruder barrel at a third location, wherein the third location is downstream of the second location.

7. The method of claim 6, wherein the solvent is a first solvent, and the method further comprises:
adding a second solvent to the extruder barrel at a fourth location, wherein the fourth location is downstream of the third location.

8. The method of claim 1, wherein the method further comprises:
adding a binder material to the extruder barrel at the second location.

9. A method of fabricating an electrode for use in an electrochemical cell that cycles lithium ions, the method comprising:
adding one or more dry powders to an extruder barrel of an extruder at a first location, wherein the one or more dry powders comprise an electroactive material;
adding one or more solvents to the extruder barrel at a second location that is downstream of the first location to form a material mixture;
applying a mixing force to the material mixture to form a paste that is a homogeneous semi-solid having a solids content greater than or equal to about 60% to less than or equal to about 90%, wherein a mixing force is continuously applied within the extruder barrel; and
extruding the paste as a continuous film onto one or more surfaces of a current collector to form the electrode, wherein the continuous film has a thickness greater than or equal to about 50 μm to less than or equal to about 500μm.

10. The method of claim 11, wherein the thickness is a first thickness, and the method further comprises:
applying a first pressure to the continuous film, such that the continuous film has a second thickness that is less than the first thickness.

11. The method of claim 10, wherein the method further comprises:
heating the continuous film using an oven having a temperature greater than or equal to about 80° C. to less than or equal to about 200° C.

12. The method of claim 11, wherein the method further comprises:
applying a second pressure to the continuous film, such that the continuous film has a porosity greater than or equal to about 20 vol % to less than or equal to about 50 vol %.

15. The method of claim 9, wherein the method further comprises:
disposing a protective film onto an exposed surfaces of the continuous film, wherein the protective film a thickness greater than or equal to about 10 μm to less than or equal to about 100 μm.

16. The method of claim 15, wherein the thickness is a first thickness, and the method further comprises:
applying a pressure to the protective film and the continuous film so the continuous film has a second thickness that is less than the first thickness;
separating the protective film and continuous film having the second thickness; and
drying the continuous film having the second thickness to remove the one or more solvents.

17. The method of claim 9, wherein the method further comprises:
adding an electronically conductive material to the extruder barrel at a third location, wherein the third location is downstream of the second location.

18. The method of claim 9, wherein the method further comprises:
adding a binder material to the extruder barrel at a third location, wherein the third location is downstream of the second location.

19. The method of claim 9, wherein the method further comprises:
adding a binder material to the extruder barrel at the second location.

20. A method of fabricating an electrode for use in an electrochemical cell that cycles lithium ions, the method comprising:
adding one or more dry powders to an extruder barrel of an extruder at a first location, wherein the one or more dry powders comprise an electroactive material;
adding one or more solvents to the extruder barrel at a second location that is downstream of the first location to form a material mixture;
applying a mixing force to the material mixture to form a paste that is a homogeneous semi-solid having a solids content greater than or equal to about 60% to less than or equal to about 90%, wherein a mixing force is continuously applied within the extruder barrel;
extruding the paste as a continuous film onto one or more surfaces of a release film, wherein the continuous film has a first thickness greater than or equal to about 50 μm to less than or equal to about 500 μm;
applying a first pressure to the continuous film such that the continuous film has a second thickness less than the first thickness;
separating the continuous film having the second thickness and the release film; and
disposing the continuous film having the second thickness on a current collector to form the electrode.
